(19) United States
(12) Patent Application Publication
(10) Pub. No.: US 2013/0239455 A1
(43) Pub. Date: Sep. 19, 2013

(54) SEINE FLOATATION DEVICE

(71) Applicant: Anthony Jordan Craig, Orange, CA (US)

(72) Inventor: Anthony Jordan Craig, Orange, CA (US)

(21) Appl. No.: 13/419,338

(22) Filed: Mar. 13, 2012

(51) Int. Cl. A01K 73/12

(52) U.S. Cl. 43/14

(57) ABSTRACT

The present invention is floatation device for seines or fishing nets, which preferably includes: at least two cork portions and one or more pairs of fastener inserts. The two cork portions are preferably opposing halves of a floatation cork configured to form a cork when combined. The one or more pairs of fasteners are preferably aligned and embedded inside the two cork portions, such that, when the one or more pairs of fasteners engage, the two or more cork portions form as a cork. Accordingly, the cork portions preferably fasten together on a fishing line after mating the fastener inserts. To increase the strength of the fastening the devices, an adhesive fastener may be included on the contact surfaces of the cork portions. The floatation device is particularly useful as a floating support for seines and commercial fishing nets.

### FIELD OF THE INVENTION

The present invention relates to floatation devices for fishing nets. Specifically, the present invention is a floatation cork device for commercial fishing nets, preferably seines, that can easily attach onto the net through the use of insert fasteners and/or protrusions.

### BACKGROUND OF THE INVENTION

Commercial fishing nets have been used for centuries and are well known in the art. Fishermen simply cast the net into the water, drag the net over areas where fish may be abundant, and pull the net to catch one or more fishes. Examples of such nets include cast nets, coracle fishing nets, dragnets, drift nets, gillnets, hand nets, lave nets, lift nets, stake nets, tangle nets, trammels, and trawls, and the like.

A common type of fishing net is a seine, which is a large net that hangs in the water. The seine typically comprises of sinkers, corks, and a net. The sinkers are attached along one end of the net and function as weights. Attached on the opposite end of the net are corks, which function as floatation devices. As the sinkers pull the net downward into the water, the net stretches due to the upward pull of the floatation devices. Thus, seines function similar to a fence, by which fishermen capture fish when the fishermen encircle the schools of fish.

Despite its benefits, seines do have some disadvantages. Preparing seines, for instance, is often cumbersome and time-consuming A fisherman typically spends hours in preparing a single seine, which usually contains thousands of corks or floatation devices. Because each individual cork may be removed and/or replaced approximately four or five at a time, this indeed becomes especially tedious with nets that are approximately three football fields long. Additionally, continuous use of fishing nets eventually results with lost or damaged corks, causing fishing nets to sink into the water. This likely causes fishermen to lose fish, which, in turn, results in losses of time and money.

Therefore, what is needed is a cork or floatation device that can be easily assembled or prepared by simply adding or replacing the fishing net's corks. The corks are preferably “snapped” onto the fishing net through the use of fastening devices.

### SUMMARY OF THE INVENTION

To minimize the limitations in the prior art, and to minimize other limitations that will become apparent upon reading and understanding the present specification, the present invention discloses a new and useful floatation device for fishing nets.

One embodiment of the present invention is a floatation device for fishing nets, comprising: two or more cork portions; and one or more pairs of fasteners. The two or more cork portions are configured to form a cork when combined, and the one or more pairs of fasteners are aligned and embedded inside the two or more cork portions, such that, when the one or more pairs of fasteners engage, the two or more cork portions combine to form the cork. Preferably, the one or more pairs of fasteners include one or more male fasteners and one or more female fasteners. Preferably, the two or more cork portions includes one or more contact surfaces, and the one or more contact surfaces may include an adhesive. The adhesive preferably increases a fastening strength of the one or more pairs of fasteners when the two or more cork portions combine. The two or more cork portions, when combined, should form one or more through holes, and the one or more through holes are typically configured to interconnect with a fishing net. Preferably, the two or more cork portions are two cork portions. The one or more male fasteners may be two male fasteners; and the one or more female fasteners may be two female fasteners. The one or more male fasteners are preferably three male fasteners; and the one or more female fasteners are preferably three female fasteners. The one or more male fasteners may be four male fasteners; and the one or more female fasteners may be four female fasteners. The two or more cork portions may be plastic.

Another embodiment of the present invention is a floatation device for fishing nets, comprising two or more cork portions. The two or more cork portions are configured to form a cork when combined, and the two or more cork portions include one or more protrusions and one or more holes. The one or more protrusions and the one or more holes are aligned on the two or more cork portions, such that, when the one or more protrusions engage with the one or more holes, the two or more cork portions combine to form the cork. Preferably, the two or more cork portions includes one or more contact surfaces. Preferably, the one or more contact surfaces includes an adhesive. Preferably, the adhesive increases a fastening strength of the one or more protrusions and the one or more holes when the two or more cork portions combine. Preferably, the two or more cork portions, when combined, form one or more through holes; wherein the one or more through holes are configured to interconnect with a fishing net. Preferably, the two or more cork portions are two cork portions. The one or more protrusions may be two protrusions; and the one or more holes may be two holes. The one or more protrusions are preferably three protrusions; and the one or more holes are preferably three holes. The one or more protrusions may be four protrusions; and the one or more holes may be four holes. The two or more cork portions should be plastic.

Another embodiment of the present invention is a floatation device for fishing nets, comprising: two cork portions and three pairs of fasteners. The two cork portions are configured to form a cork when combined. The three pairs of fasteners are aligned and embedded inside the two cork portions, such that, when the three pairs of fasteners engage, the two cork portions combine to form the cork. The two or more cork portions includes one or more contact surfaces. The one or more contact surfaces include an adhesive. The adhesive increases a fastening strength of the three pairs of fasteners when the two or more cork portions combine. The two or more cork portions, when combined, form one or more through holes; and the one or more through holes are configured to interconnect with a fishing net.

It is an object of the present invention to provide a cork or floatation device for fishing nets, in which a user may easily “cork” or prepare a whole net.

It is an object of the present invention to provide a cork or floatation device to allow fishermen to easily replace the floatation devices to save time and money in re-corking.

It is an object of the present invention to provide a floatation device that is inexpensive and easy to manufacture.

It is an object of the present invention to provide a floatation device that is durable.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective-exploded view of one embodiment of the floatation device with fasteners.

FIG. 2 is an illustration of a side view of one embodiment of the floatation device with fasteners embedded in the cork portions and shows the floatation device before combining the cork portions.

FIG. 3 is an illustration of a cross-sectional side view of one embodiment of the floatation device with fasteners embedded in the cork portions and shows the floatation device before combining the cork portions.

FIG. 4 is an illustration of a side view of one embodiment of the floatation device and shows the floatation device after combining the cork portions.

FIG. 5 is an illustration of a cross-sectional side view of one embodiment of the floatation device with fasteners and shows the floatation device after combining the cork portions.

FIG. 6 is an illustration of a perspective view of one embodiment of the floatation device after combining the cork portions.

FIG. 7 is an illustration of a perspective view of one embodiment of the floatation device with protrusions and shows the floatation device before combining the cork portions.

FIG. 8 is an illustration of a cross-sectional side view of one embodiment of the floatation device with protrusions and shows the floatation device before combining the cork portions.

FIG. 9 is an illustration of a cross-sectional side view of one embodiment of the floatation device with protrusions and shows the floatation device after combining the cork portions.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “cork” refers to any floatation device used on a fishing line or net to buoy up the line or net. The terms “fishing net” or “net” refers to any type of netting device used for fishing, including without limitation, cast nets, coracle fishing nets, Chinese nets, dragnets, drift nets, drive-in nets, fyke nets, gillnets, ghost nets, hand nets, lave nets, lift nets, plankton nets, seines, stake nets, surrounding nets, tangle nets, trammels, and trawls. The term “fastener” refers to any device that attaches one piece to another piece, including without limitation, insert fasteners, male and female fasteners, straps, hook and loop fasteners, screws, bolts, wires, nylons, snap hooks, loops, solder, flux, nuts, washers, rivets, turnbuckles, and the like. The term “adhesive” refers to any type of material that adheres or bonds the cork portions together, including without limitation, adhesive attached-nylon plastic, animal glue (e.g., bone glue, fish glue, hide glue, hoof glue, rabbit skin glue); albumin glue; casein glue; meat glue; plant-based glue; Canada balsam (natural resin); coccoina; gum Arabic (e.g., postage stamp gum); latex; library past; methyl cellulose; mucilage; resorcinol resin; starch; urea-formaldehyde resin; poslystyrene cement/Butanone; dicloromethane; monomers (acrylonitrile, cyanoacrylate, acrylic, resorcinol glue); polymer glues (epoxy, epoxy putt, ethylene-vinyl acetate, phenol formaldehyde resin, polyamide, polyester resins, polyethylene, polypropylene, polysulfides, polyurethane, polyvinyl acetate, polyvinyl alcohol, polyvinyl chloride, polyvinylpyrrolidone, rubber cement, silicones, and styrene acrylic copolymers.

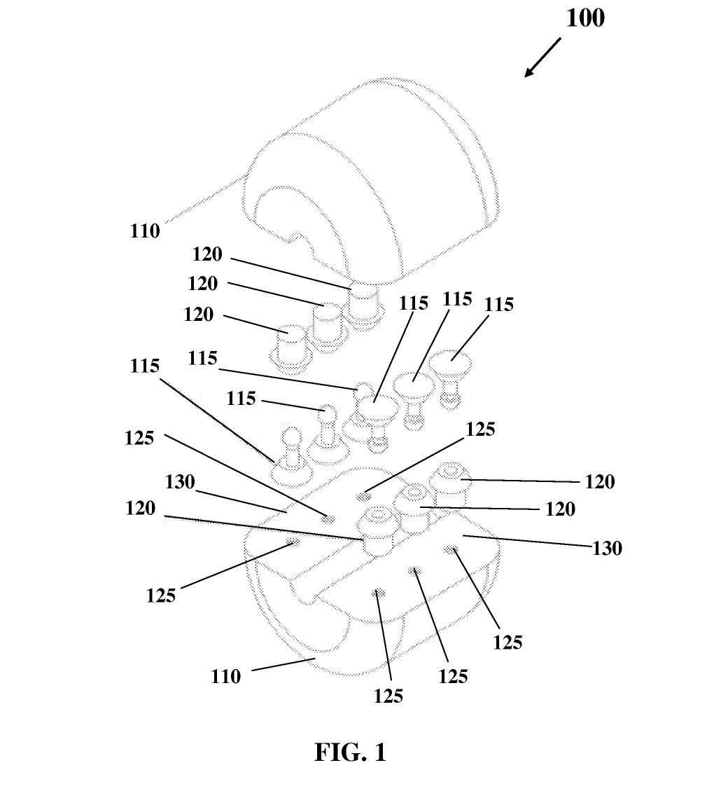

FIG. 1 is an illustration of a perspective-exploded view of one embodiment of the floatation device with fasteners. As shown in FIG. 1, the floatation device 100 preferably includes: cork portions 110; male fasteners 115; and female fasteners 120. The cork portions 110 are preferably structural pieces of the cork or floatation device, which are preferably used for fishing nets such as seines. The cork portions 110 are also preferably configured to form a single, cylindrical cork when combined. While FIG. 1 shows an exploded view of a cylindrical-shaped cork, the present invention allows the cork to be configured in any shape or form such as square, rectangle, oval, and sphere. Additionally, while FIG. 1 only shows two cork portions 110 as half pieces of the cork, the present invention allows multiple pieces of cork portions to be used such as three, four, or five pieces.

FIG. 1 shows the cork portions 110 as two half pieces of a single cork, which preferably include a plurality of holes 125. The holes are generally configured to accept or receive the male fasteners 115 and/or female fasteners 120. Preferably, when the fasteners are embedded in the cork portions 110, the male fasteners 115 and female fasteners 120 are generally aligned, such that a user can combine the cork portions 110 to form the cork or floatation device. Although FIG. 1 only shows only six holes for each cork portion 110, the present invention allows the cork portion 110 to include any number of holes. The cork portion 110 also preferably includes a contact surface 130, which is typically a flat-surface area in which the cork portions 110 contact each other. Although FIG. 1 shows the contact surface 130 as a flat surface area, the contact surface 130 may be unbalanced or irregular without deviating from the scope of the invention. The contact surface 130 may include an adhesive to increase the strengthening bond or fastening strength of the fasteners when the cork portions 110 combine. The adhesive is typically a glue, epoxy, or cement compound but may be constructed of any manmade or non-manmade composite that increases the fastening strength of the cork portions 110.

FIG. 1 shows the male fasteners 115 and female fasteners 120, which are preferably fastener inserts for the cork portions 110. The male fasteners 115 and female fasteners 120 are preferably embedded in the cork portions 110 and are typically configured to secure the cork portions 110 together when both the male fasteners 115 and female fasteners 120 engage or mate. As discussed above, the male fasteners 115 and female fasteners 120 are aligned and embedded inside the holes 125 of the cork portions 110, such that when the male fasteners 115 and female fasteners 120 mate or engage, the cork portions 110 combine to form a cork. Although FIG. 1 only shows three pairs of male fasteners and female fasteners, the present invention allows any amount of fasteners to be used, so long as the cork portions 110 are capable to be combined as a single cork.

The cork portions 110, male fasteners 115, and female fasteners 120 are typically constructed of light-weight materials, including without limitation, high-strength plastic or polymers, but may be constructed of any natural or manmade material such as ethylene vinyl acetate (EVA), polyethylene, polyethylene vinyl acetate (PEVA), polyvinyl chloride (PVC), polyvinyl, polystyrene, fibers, textiles, polyamides, and polycarbonates. Also, the cork, which is formed by the present invention, is preferably buoyant, such that when the cork is in contact with a liquid surface, the cork buoys or floats on the liquid surface.

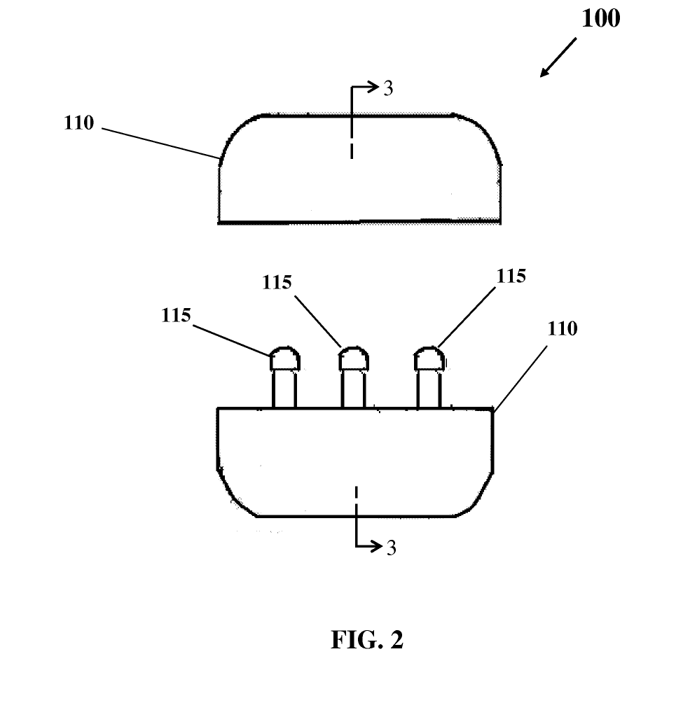

FIG. 2 is an illustration of a side view of one embodiment of the floatation device with fasteners embedded in the cork portions and shows the floatation device before combining the cork portions. As shown in FIG. 2, the floatation device 100 preferably includes cork portions 110 and male fasteners 115, and typically includes female fasteners 120, which are shown in FIGS. 1, 3, and 5.

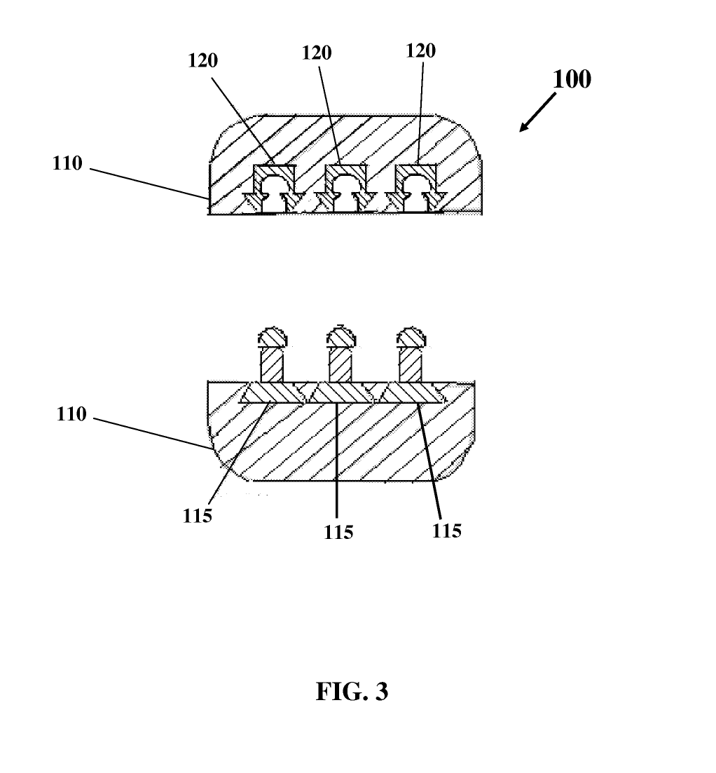

FIG. 3 is an illustration of a cross-sectional side view of one embodiment of the floatation device with fasteners embedded in the cork portions and shows the floatation device before combining the cork portions. As shown in FIG. 3, the floatation device 100 preferably includes: cork portions 110; male fasteners 115; and female fasteners 120. The cork portions 110 preferably form into a single cork or floatation device 100 when combined. As discussed above, the male fasteners 115 and female fasteners 120 are preferably aligned and embedded inside the holes 125 of the cork portions 110, such that when the male fasteners 115 and female fasteners 120 mate or engage, the cork portions 110, in combination with the male fasteners 115 and female fasteners 120, combine to form a cork.

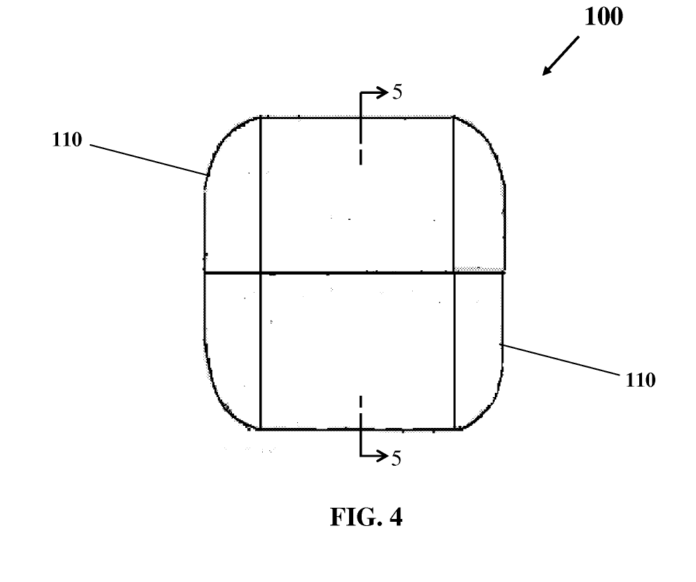

FIG. 4 is an illustration of a side view of one embodiment of the floatation device and shows the floatation device after combining the cork portions. As shown in FIG. 4, the floatation device 100 preferably includes two cork portions 110, which preferably form into a cork or floatation device. Although FIG. 4 only shows two cork portions 110 combined, the floatation device 100 may include any number of cork portions without deviating from the scope of the invention.

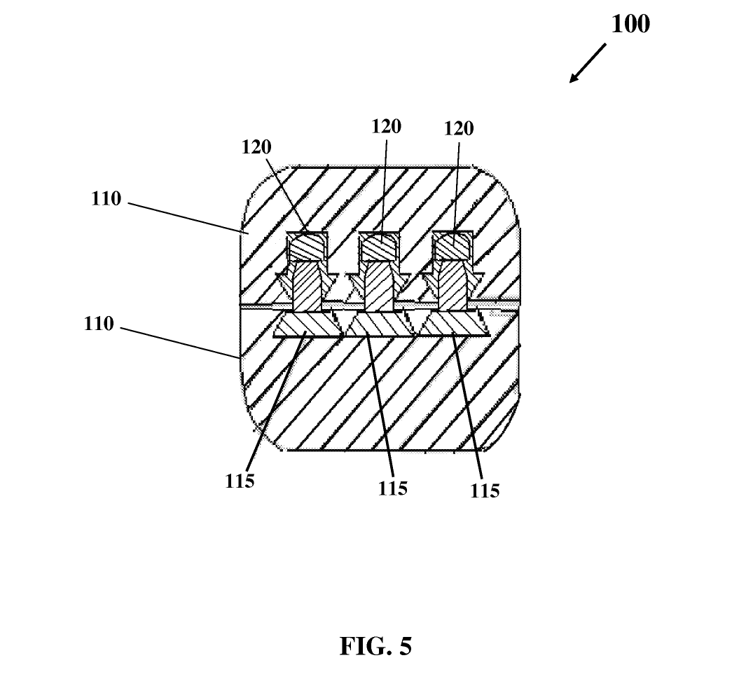

FIG. 5 is an illustration of a cross-sectional side view of one embodiment of the floatation device with fasteners and shows the floatation device after combining the cork portions. As shown in FIG. 5, the floatation device 100 preferably includes: cork portions 110; male fasteners 115; and female fasteners 120. The cork portions 110 preferably form into a single cork or floatation device when combined. The male fasteners 115 and female fasteners 120 are preferably aligned and embedded inside the holes 125 of the cork portions 110, such that when the male fasteners 115 and female fasteners 120 mate or engage, the cork portions 110, in combination with the male fasteners 115 and female fasteners 120, combine to form a cork.

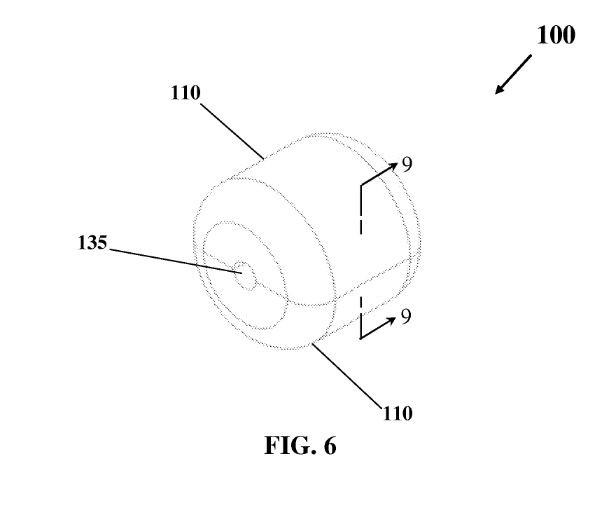

FIG. 6 is an illustration of a perspective view of one embodiment of the floatation device after combining the cork portions. As shown in FIG. 6, the floatation device 100, when combined as a cork, preferably includes cork portions 110 and a through hole 135. The through hole 135 is preferably a hole that passes all the way through the cork, but may also be a blind hole, which does not go all the way through the cork. The through hole 135 is preferably configured to receive, attach, or interconnect with a portion of the fishing net, to provide the fishing net with buoyancy. Preferably, the through hole 135 allows the cork to be fixedly attached to the fishing net, but may allow the cork to slide or glide along the fishing net. Additionally, the fishing net is typically constructed of any manmade or non-manmade material, which includes corks, cork line, collar webbing, chaffing, and lead line.

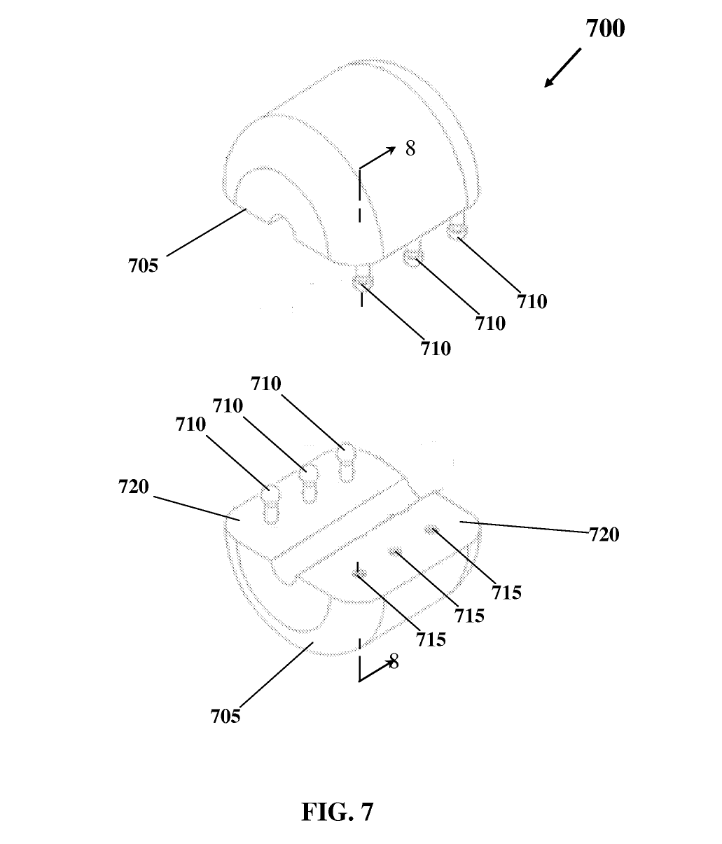

FIG. 7 is an illustration of a perspective view of one embodiment of the floatation device with protrusions and shows the floatation device before combining the cork portions. As shown in FIG. 7, the floatation device 700 preferably includes cork portions 705, protrusions 710, and holes 715. Similar to the male fasteners 115 and female fasteners 120, the protrusions 710 and holes 715 are preferably aligned on the contact surface 720 of the cork portions 705, such that when the protrusions 710 and holes 715 mate or engage, the cork portions 705 combine to form a single cork or floatation device 700. Additionally, the contact surfaces 720 may include an adhesive to increase the bond or fastening strength when the cork portions 705 are combined. Although FIG. 7 only shows the floatation device 700 with protrusions, it should be understood that the present invention allows the floatation device to include a combination of both protrusions and fasteners without deviating from the scope of the invention.

Preferably, the protrusions 710, like the fasteners, are made out of light-weight materials, such as hardened plastic or polymers, but any natural or manmade material may be used. Although FIG. 7 only shows three pairs of protrusions 710 and holes 715, the present invention allows any amount of protrusions and holes to be used without deviating from the scope of the invention.

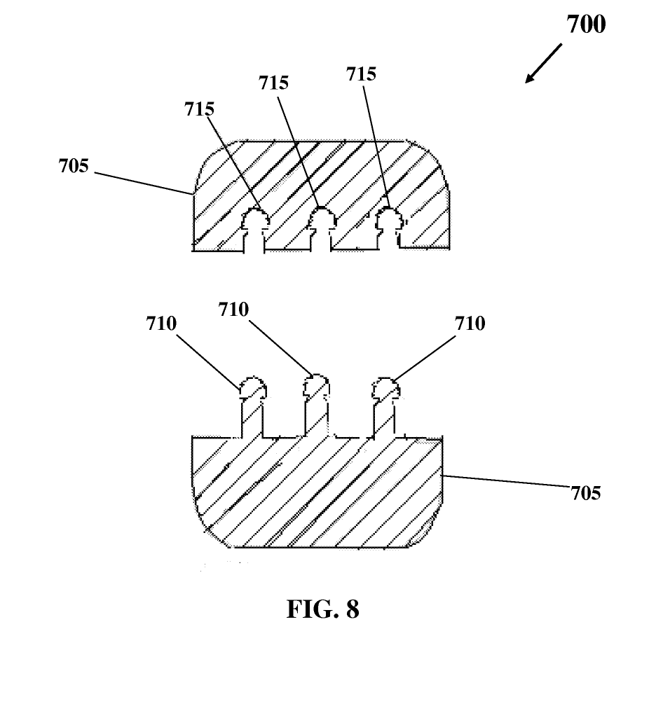

FIG. 8 is an illustration of a cross-sectional side view of one embodiment of the floatation device with protrusions and shows the floatation device before combining the cork portions. As shown in FIG. 8, the floatation device 700 preferably includes: cork portions 705; holes 715; and protrusions 710. The holes 715 and protrusions 710, as discussed above, are preferably aligned such that when the holes 715 and protrusions 710 mate or engage, the cork portions 705 combine to form a cork or floatation device 700.

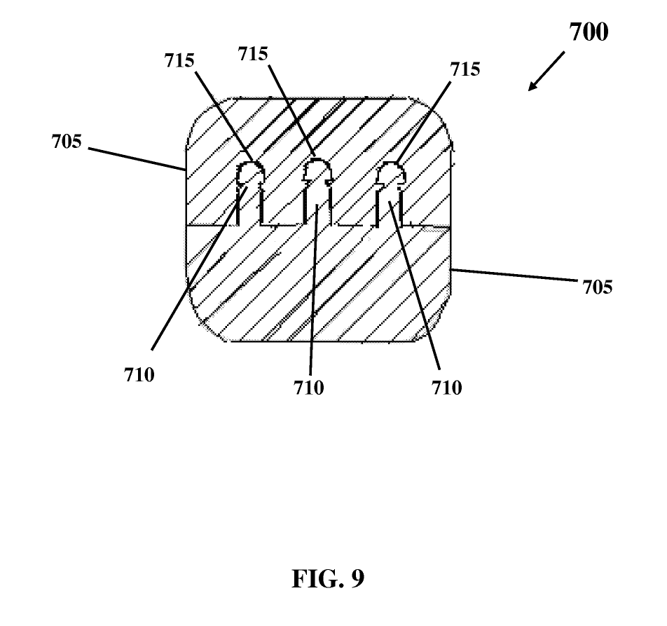

FIG. 9 is an illustration of a cross-sectional side view of one embodiment of the floatation device with protrusions and shows the floatation device after combining the cork portions. As shown in FIG. 9, the floatation device 700 preferably includes: cork portions 705; protrusions 710; and holes 715. The protrusions 710 and holes 715 preferably mate or engage to form a single cork or floatation device 700.

In preparing or applying the cork or floatation device 100, 700 to a fishing net or rope, the user typically combines the cork portions 110, 705, in combination with fasteners 115, 120 and/or protrusions 710. When the cork portions 110, 705 combine, the through hole 135 preferably circumscribes or encircles the fishing net or rope. Preferably, adhesive material is also included on the contact surfaces 130, 720 to strengthen the fastening of the cork portions 110, 705. After the cork portions 110, 705 are combined to form a cork for the fishing net, the cork or floatation device 100, 700 provides buoyancy for the fishing net.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A floatation device for fishing nets, comprising:
two or more cork portions; and
one or more pairs of fasteners;
wherein said two or more cork portions are configured to form a cork when combined; and
wherein said one or more pairs of fasteners are aligned and embedded inside said two or more cork portions, such that, when said one or more pairs of fasteners engage, said two or more cork portions combine to form said cork.

2. The floatation device, according to claim 1, wherein said one or more pairs of fasteners include one or more male fasteners and one or more female fasteners.

3. The floatation device, according to claim 2, wherein said two or more cork portions includes one or more contact surfaces;
wherein said one or more contact surfaces includes an adhesive; and
wherein said adhesive increases a fastening strength of said one or more pairs of fasteners when said two or more cork portions combine.

4. The floatation device, according to claim 3, wherein said two or more cork portions, when combined, form one or more through holes;
wherein said one or more through holes are configured to engage with a fishing net.

5. The floatation device, according to claim 4, wherein said two or more cork portions are two cork portions.

6. The floatation device, according to claim 5, wherein said one or more male fasteners are two male fasteners; and wherein said one or more female fasteners are two female fasteners.

7. The floatation device, according to claim 5, wherein said one or more male fasteners are three male fasteners; and wherein said one or more female fasteners are three female fasteners.

8. The floatation device, according to claim 5, wherein said one or more male fasteners are four male fasteners; and wherein said one or more female fasteners are four female fasteners.

9. The floatation device, accordingly to claim 5, wherein said two or more cork portions are plastic.

10. The floatation device, accordingly to claim 5, wherein said two or more cork portions are configured to float.

11. A floatation device for fishing nets, comprising:
two or more cork portions;
wherein said two or more cork portions are configured to form a cork when combined;
wherein said two or more cork portions include one or more protrusions and one or more holes; and
wherein said one or more protrusions and said one or more holes are aligned on said two or more cork portions, such that, when said one or more protrusions engage with said one or more holes, said two or more cork portions combine to form said cork.

12. The floatation device, according to claim 11, wherein said two or more cork portions includes one or more contact surfaces;
wherein said one or more contact surfaces includes an adhesive; and
wherein said adhesive increases a fastening strength of said one or more protrusions and said one or more holes when said two or more cork portions combine.

13. The floatation device, according to claim 12, wherein said two or more cork portions, when combined, form one or more through holes;
wherein said one or more through holes are configured to interconnect with a fishing net.

14. The floatation device, according to claim 13, wherein said two or more cork portions are two cork portions.

15. The floatation device, according to claim 14, wherein said one or more protrusions are two protrusions; and wherein said one or more holes are two holes.

16. The floatation device, according to claim 14, wherein said one or more protrusions are three protrusions; and wherein said one or more holes are three holes.

17. The floatation device, according to claim 14, wherein said one or more protrusions are four protrusions; and wherein said one or more holes are four holes.

18. The floatation device, accordingly to claim 14, wherein said two or more cork portions are plastic.

19. A floatation device for fishing nets, comprising:
two cork portions; and
three pairs of fasteners;
wherein said two cork portions are configured to form a cork when combined;
wherein said three pairs of fasteners are aligned and embedded inside said two cork portions, such that, when said three pairs of fasteners engage, said two cork portions combine to form said cork;
wherein said two or more cork portions includes one or more contact surfaces;
wherein said one or more contact surfaces includes an adhesive;
wherein said adhesive increases a fastening strength of said three pairs of fasteners when said two or more cork portions combine;
wherein said two or more cork portions, when combined, form one or more through holes; and
wherein said one or more through holes are configured to interconnect with a fishing net.
